(19) United States
(12) Patent Application Publication
(10) Pub. No.: US 2025/0335173 A1
(43) Pub. Date: Oct. 30, 2025

(54) METHOD AND SYSTEM FOR NETWORK UPGRADE BASED ON PERSONALIZED SCHEDULING VIA AI

(71) Applicant: Verizon Patent and Licensing Inc., Basking Ridge, NJ (US)

(72) Inventors: Durgesh Kumar, Bangalore (IN); Saurabh Tahiliani, Noida (IN)

(73) Assignee: Verizon Patent and Licensing Inc., Basking Ridge, NJ (US)

(21) Appl. No.: 18/645,751

(22) Filed: Apr. 25, 2024

(51) Int. Cl. G06F 8/65; G06Q 50/00

(52) U.S. Cl. CPC G06F 8/65; G06Q 50/01

(57) ABSTRACT

The present teaching relates to personalized network update. Information on users' network activities is collected and analyzed to identify indirect and direct relations between each user and others. Each user's network influence is determined and represented based on indirect relation embeddings and direct relation embeddings, obtained to characterize the respective indirect and direct relations. A personalized priority for each user is predicted based on the user's representation. A network update schedule is determined based on users' personalized priorities so that network update is conducted in a personalized manner.

### BACKGROUND

Telecommunications networks provide connectivity through infrastructure, whether wired or wireless, in addition to data and voice services to millions of connected users. Network services may be rendered via applications running on many different network nodes connected to the users who use such services. These networks need to be upgraded regularly and during the upgrades, temporary interruptions to network connections may occur, leading to degradation in services for many users. Because of that, often network upgrades can negatively impact network performance, which leads to bad user experience.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A shows an exemplary network with multiple sub-nets connected to different entities;

FIG. 1B illustrates different types of updates to a network;

FIG. 2A depicts an exemplary framework for updating a network according to personalized schedules devised based on individually learned entity priorities, in accordance with an embodiment of the present teaching;

FIG. 2B is a flowchart of an exemplary framework for updating a network according to personalized schedules devised based on individually learned entity priorities, in accordance with an embodiment of the present teaching;

FIG. 3A depicts an exemplary high level system diagram of a priority determination module, in accordance with an embodiment of the present teaching;

FIG. 3B is a flowchart of an exemplary process for a priority determination module, in accordance with an embodiment of the present teaching;

FIG. 4A depicts an exemplary high level system diagram of an entity representation generator, in accordance with an embodiment of the present teaching;

FIG. 4B is a flowchart of an exemplary process for an entity representation generator, in accordance with an embodiment of the present teaching;

FIG. 5A illustrates exemplary types of information assessed to determine indirect relations among different users in a network, in accordance with an embodiment of the present teaching;

FIG. 5B shows an exemplary graph constructed based on indirection relations among users, in accordance with an embodiment of the present teaching;

FIG. 5C illustrates exemplary types of information used for determining direct relations among different users in a network, in accordance with an embodiment of the present teaching;

FIG. 5D shows an exemplary graph constructed based on direction relations among users, in accordance with an embodiment of the present teaching;

FIG. 5E shows an exemplary scheme for generating a user representation based on indirect and direction relations with others, in accordance with an embodiment of the present teaching;

FIG. 6A depicts an exemplary high level system diagram of a priority determiner, in accordance with an embodiment of the present teaching;

FIG. 6B is a flowchart of an exemplary process of a priority determiner, in accordance with an embodiment of the present teaching;

FIG. 6C shows an exemplary implementation of a priority determiner using an artificial neural network, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

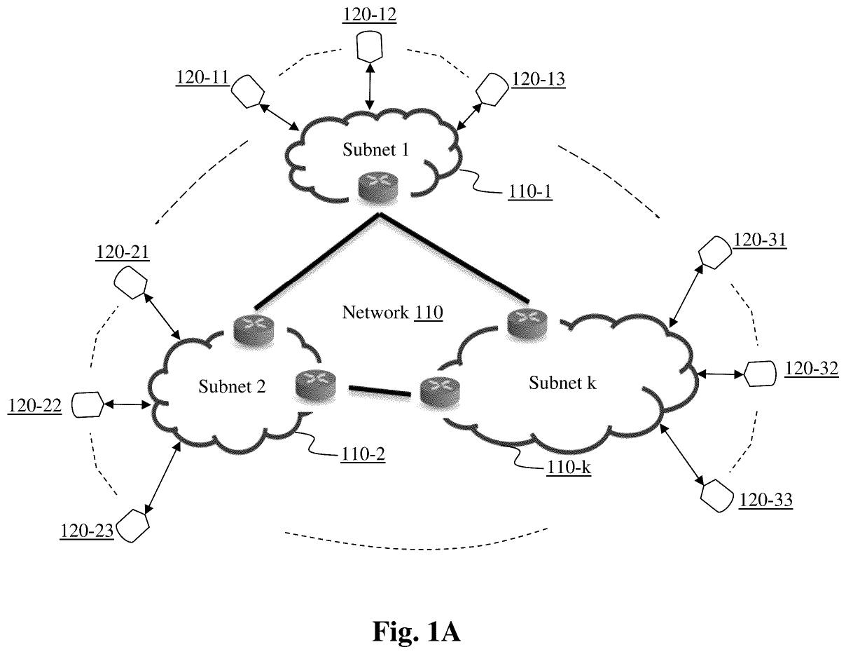

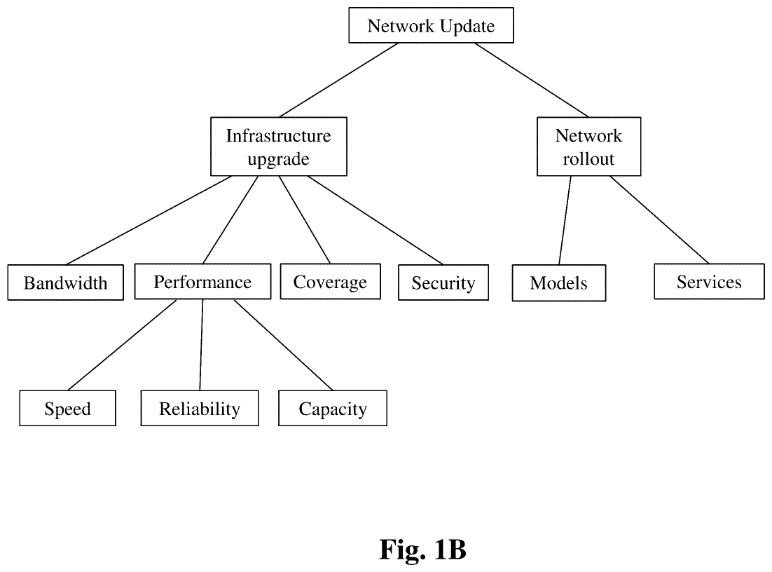

In a modern network, a network may have different sub-networks (subnets), each of which may serve a collection of users. This is illustrated in FIG. 1A, where a network 110 may comprise k subnets 110-1, 110-2, . . . , 110-k and each of the subnet may cover a separate geographic area serving users 120 in that geolocation. For example, a network providing network services in the United States may include three subnets, covering, e.g., the east coast, west coast, and mid-west of the country. Each subnet may serve users in different geolocations. Such a network may be regularly updated. FIG. 1B shows exemplary types of network update that may be performed, such as upgrade to network infrastructure and different network rollouts. Upgrades to network infrastructure may be carried out for different purposes, including, e.g., for improved network bandwidth, network performance, geographical coverage, and network security. Network performance may be enhanced in terms of speed of the network transmission, reliability of the network operation, and capacity associated with the network. Network rollouts may be directed to distributing new models used in services and/or network-wide services.

Network upgrades and rollouts may happen frequently. As such network upgrades/rollouts are generally time consuming and may cause possible disruptions. Millions of users connected to the network may be negatively impacted due to the upgrade causing, e.g., unexpected downtime, lost productivity, and increased costs. Network users may broadly include entities receiving services, including customers (such as enterprises, companies, households, and individuals) and/or other types of service recipients (such as data transport paths, etc.). Efforts have been made to minimize negative impact to network users via some blanket prioritization schemes. For example, updates may be carried out in a manner to minimize disruptions in high population regions (e.g., urban areas). In some update schemes, regions with a population with demographics corresponding to higher incomes may also be taken into consideration. However, such blanket prioritization schemes are not capable of adequately minimizing the negative impact as they do not consider the individual influences of different users and the spread of negative impact when influential users are negatively affected due to network upgrades and/or network rollouts.

The present teaching is directed to a dynamic prioritization scheme for network upgrades and rollouts, with hyper-personalized approach to achieve brand recognition, customer retention, and budget optimization. With respect to each user, which may correspond to an enterprise, a business, a household, or an individual, a prioritization evaluation is individually determined based on a characterization of the user's network influence. In some embodiments, the network influence may be evaluated based on the user's indirect and direct relationships with others in the network. The prioritization evaluation with respect to a user may be represented by a score indicating the importance or influence of the user so that the network upgrades and rollout may be carried out to minimize the negative impact on those users that have higher levels of network influence or may have higher levels of importance.

In some embodiments, user importance may be assessed in terms of how the user is indirectly related to other users as well as how the user has direct influence on others. For example, a user may be indirectly related to others via different types of network activities. Such indirect relationships serve as a conduit to spread impact on others in the network due to network upgrades/rollouts. Indirect relationships associated with a user may be captured via machine learning based on the observed user's activities and represented as the user's indirect relation embeddings. Indirect relationships among different users may be obtained via a graph representation, characterizing how different users are connected on the network. A user with closer indirect relations to a wider range of other users may indicate a higher level of the user's indirect influence to others.

A user may also have direct influence on others. In some embodiments, a degree of a user's direct influence on others may be estimated based on the direct interactions between a user and others via network connections. Such direct interactions may provide an indication as to a level of a user's direct relation with others and may be used via machine learning to obtain the user's direct relation embeddings that represent the user's direct influence on others on the network. In some embodiments, direct influences among different users may be represented via a graph with connection between different users characterized based on a metric characterizing a level of direct influence determined based on, e.g., respective direct relation embeddings of the two users. Via the graph representation, users' direct relation to others across the network may be determined.

The indirect and direction relations between a user and others may be used in combination to obtain a representation for the user characterizing the user's influence across the network. Each user's representation determined as such may then be used to determine an individual priority so that a hyper-personalized schedule for network upgrades/rollout operations may be derived based on users' priorities to minimize the negative impact to whoever may be affected. In some embodiments, machine learning is applied to train a prediction mechanism to map a user representation to an evaluation metric indicating the user's priority level. The hyper-personalized scheduling for network update may be performed dynamically so that the schedules for network updates may be created adaptively over time based on the changing dynamics of user activities.

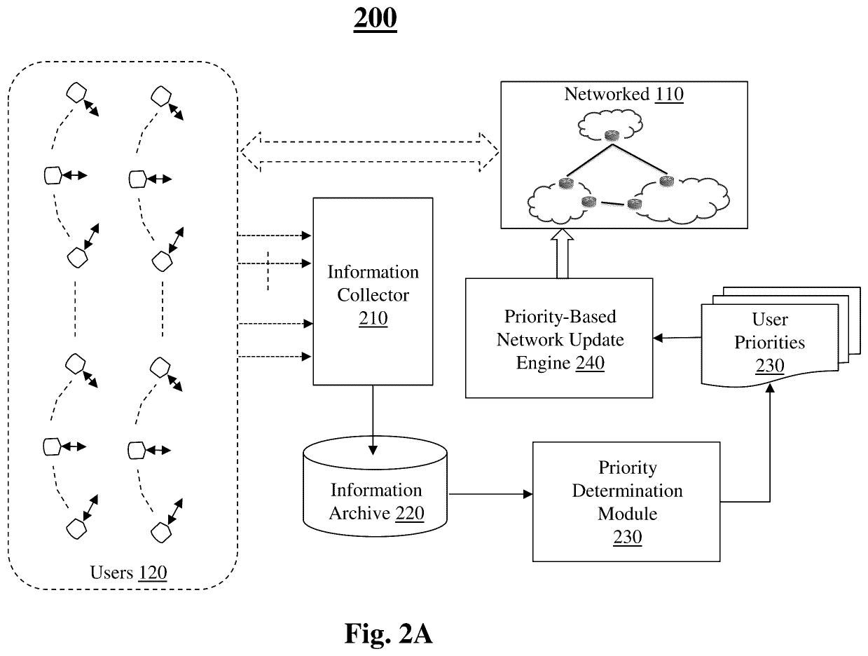

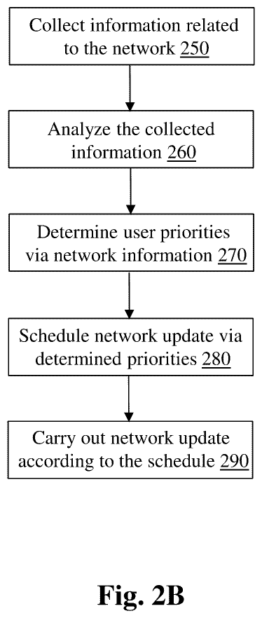

FIG. 2A depicts an exemplary framework 200 for updating a network according to personalized schedules devised based on individually learned entity priorities, in accordance with an embodiment of the present teaching. As discussed herein, a network 110 may provide services to users 120. To minimize the negative impact of network update to users, the illustrated framework 200 includes an information collector 210, a priority determination module 230, and a priority-based network update engine 240. The information collector 210 may be provided to gather information related to user activities and store such information in an information archive 220. The priority determination module 230 may be provided to analyze the gathered information from archive 220 to determine each user's priority representing the user's influence in the network. Such determined user priorities 230 may then be used by the priority-based network update engine 240 to devise a personalized network update schedule for network update and carry out the update accordingly.

FIG. 2B is a flowchart of an exemplary framework for updating a network according to personalized schedules devised based on individually learned user priorities, in accordance with an embodiment of the present teaching. At 250, the information collector 210 collects information related to user activities on the network. To assess the influence of individual users, the priority determination module 230 analyzes, at 260, the collected information and determines, at 270, priority associated with individual users. Such individually determined user priorities 230 may represent the users' network influences and may be relied on by the priority-based network update engine 240 to schedule, at 280, the next network update in a personalized manner to minimize the negative impact to users and carry out the network update, at 290, according to the schedule.

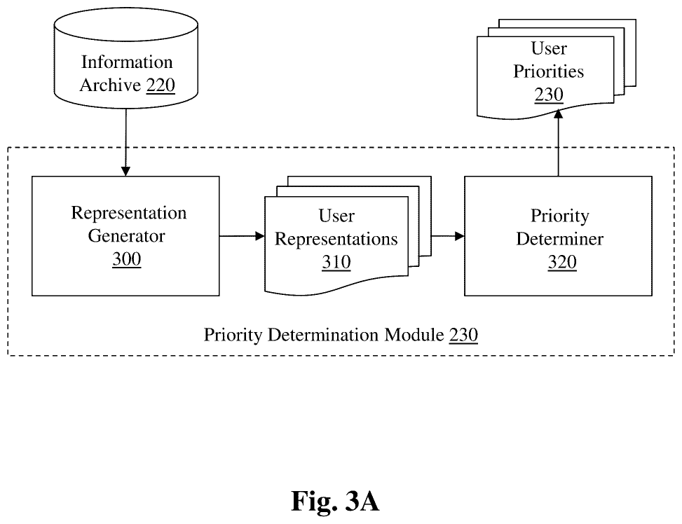

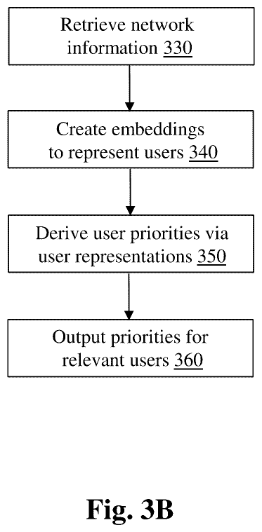

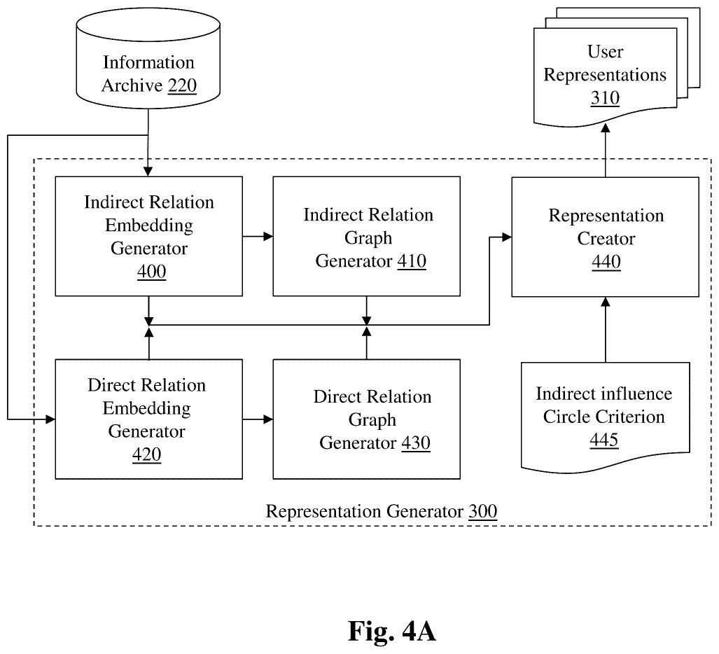

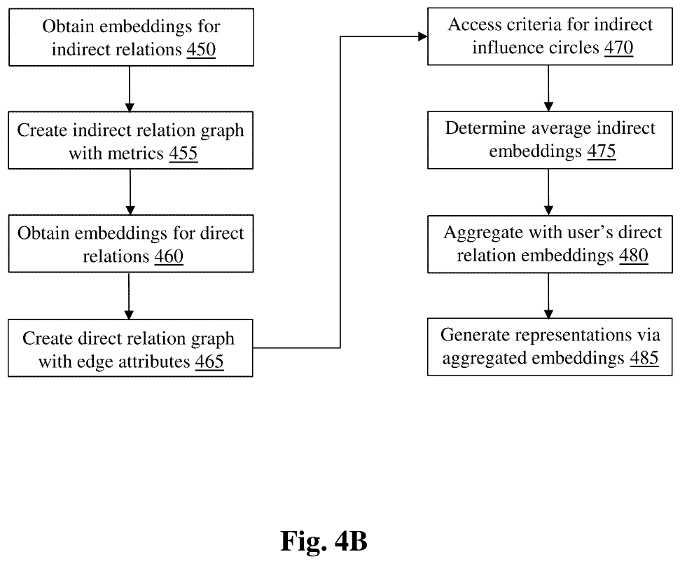

FIG. 3A depicts an exemplary high level system diagram of the priority determination module 230, in accordance with an embodiment of the present teaching. As discussed herein, based on the collected information related to user activities, a representation for each user may be obtained to characterize the user's network influence, based on which the user's individual priority may be assessed to derive a hyper-personalized priority. As illustrated in FIG. 3A, the priority determination module 230 may include a representation generator 300 for obtaining user representations 310 for network users and a priority determiner 320 for deriving user priorities 230 in accordance with the user representations 310. FIG. 3B is a flowchart of an exemplary process for the priority determination module 230, in accordance with an embodiment of the present teaching. Upon retrieving the information collected, the representation generator 300 creates, at 340, user representations 310. In some embodiments, a user representation may correspond to a feature vector or embeddings characterizing each individual user's network influence. The user representations 310 provide base information for the priority determiner 320 to derive, at 350, personalized priority for each user and archive, at 360, such user priorities 230. Details related to creating a user representation and deriving the user's priority are provided herein with reference to FIGS. 4A-6C.

FIG. 4A depicts an exemplary high level system diagram of the representation generator 300, in accordance with an embodiment of the present teaching. As discussed herein, a user's network influence may be the basis for establishing a representation of the user and the network influence may be estimated based on direct and indirect relations between the user and others in the network. The representation generator 300 may include components for assessing the direct and indirect relations of each user and for creating a representation based on such assessments. As illustrated in FIG. 4A, the representation generator 300 comprises an indirect relation embedding generator 400, an indirect relation graph generator 410, a direct relation embedding generator 420, a direct relation graph generator 430, and a representation creator 440.

The indirect relation embedding generator 400 may be provided for obtaining embeddings characterizing a user's indirect relations with others. The indirect relation graph generator 410 may be provided to construct an indirect relation graph depicting similarities among users in terms of their indirect relation characteristics based on their respective indirect relation embeddings. The direct relation embedding generator 420 may be provided for obtaining embeddings for each user representing the user's direct relations with others. The direct relation graph generator 430 may be provided to construct a direct relation graph that captures similarities among different users based on their characteristics in terms of direct relations with others. The representation creator 440 may be provided for generating a representation for each user based on embeddings associated with the indirect and direction relations between the user and others in the network.

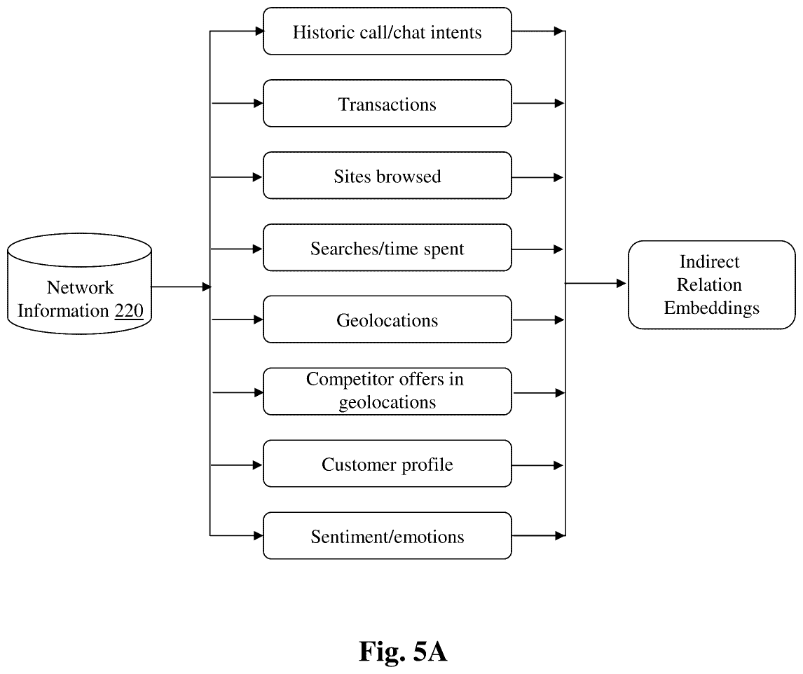

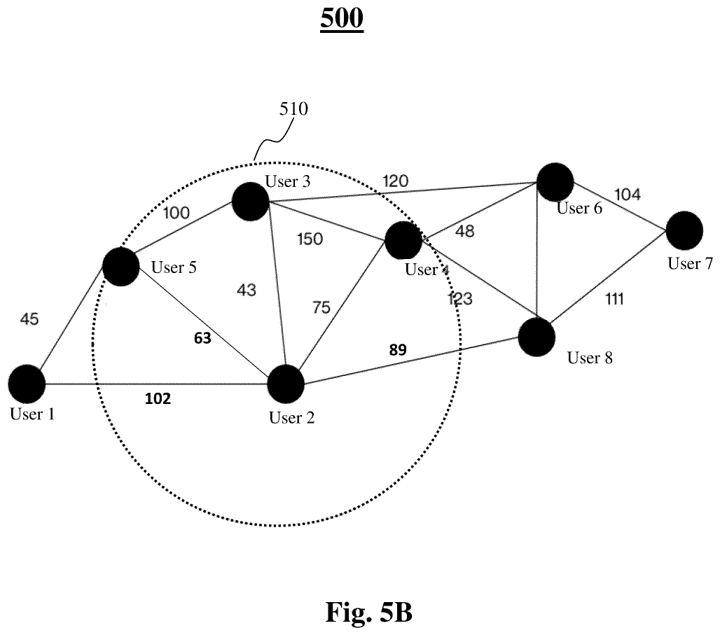

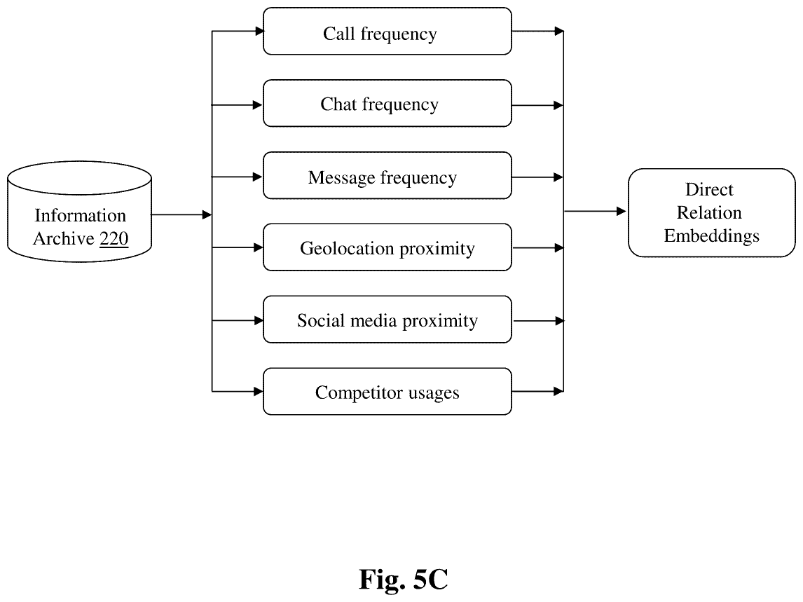

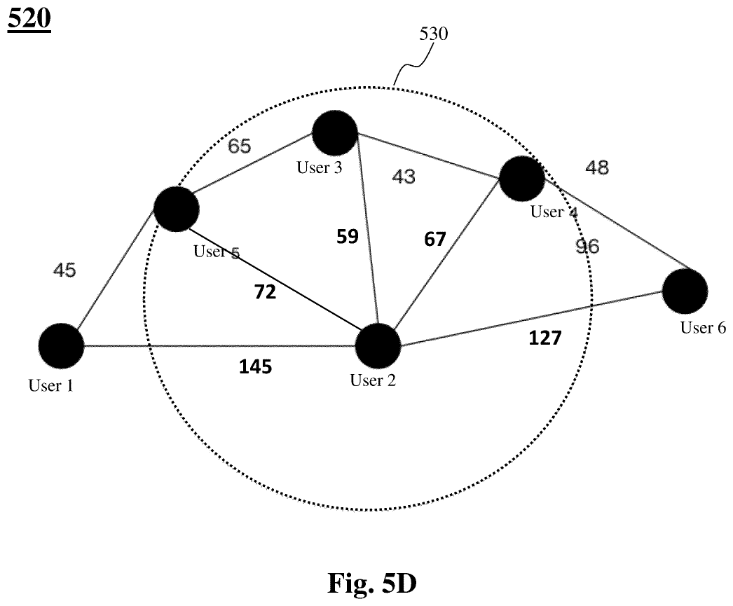

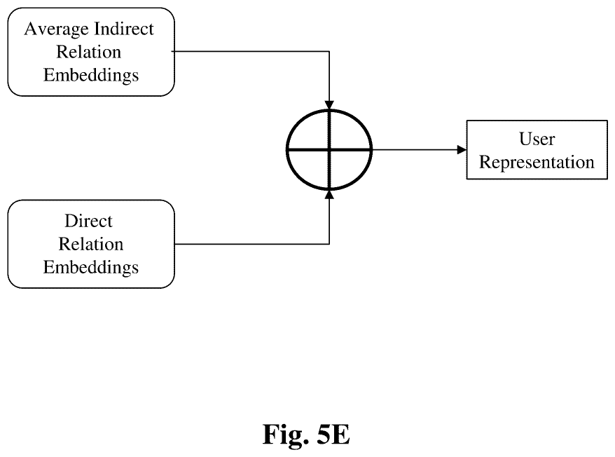

FIGS. 5A-5D show exemplary types of information that may be collected and considered in obtaining embeddings that characterize individual users as to their network influence. FIG. 5A illustrates different types of information used in obtaining embeddings to represent a user's indirect relations. As shown in FIG. 5A, from the information archived in 220, information on intents exhibited with respect to historic calls/chats, past transactions performed over the network with other entities, websites the user browsed, searches performed by the user and the amount of time the user spent thereon, the geolocations where the user had been active and offers made by competitors to the user at such geolocations, sentiments/emotions the user had shown in different network activities, and information included in a personal profile associated with the user. Such exemplary information with respect to each user may be retrieved from the archive 220 and used to train an indirect relation embedding generator to obtain corresponding indirect relation embeddings for the user.

FIG. 5B shows an exemplary graph 500 representing users in a network based on characteristics related to indirect relations, in accordance with an embodiment of the present teaching. In this exemplary graph 500, each node represents a user characterized by the user's indirect relation embeddings and each edge represents a similarity between two nodes (users) with respect to their indirect relations (characterized by their respective indirect relation embeddings). In some embodiments, each edge in graph 500 may be denoted with an attribute characterizing the similarity between two users and may be determined via a distance metric determined, e.g., based on the respective indirect relation embeddings of the two connected users. In this case, the shorter the distance between two users, the more similar the two users are in terms of their indirect influence to others in the network. Based on graph 500, users that have a similar degree of indirect influence in the network as a particular user may be identified.

Depending on application needs, a criterion may be specified to define what constitute a similar degree of indirect influence in the network. For example, whenever a distance metric between two nodes in graph 500 is smaller than a threshold, the two users connected thereto may be considered as having a similar degree of indirect influence. This may be assessed with respect to each user. As illustrated in FIG. 5B, user 2, user 3, user 4, and user 5 may be considered as users that have similar indirect influence, if the criterion is that the distance is smaller than 80. In this case, circle 510 encloses 4 users as having similar indirect influence in the network. A user's indirect influence may go beyond those that the user has indirect relations as those users may also have additional indirect relations with more others in the network. Given that, identifying those with a similar degree of indirect influence may be useful so that the degree of indirect influence of a user may be assessed more reliably. For example, indirect relation embeddings of those assessed as similar may be averaged to represent an average degree of indirect influence.

FIG. 5C illustrates exemplary types of information considered in capturing direct relation characteristics of each user, in accordance with an embodiment of the present teaching. As shown in FIG. 5C, information used in assessing direct relation between a user and others may include the frequencies of calls/chats/messages that a user had with others (the higher the frequency, the higher the direct influence), the proximity of the user geographically with others connected with direct relations (the closer, the more influence), the proximity of the user with others in different social media settings, and the frequency of using other competitor's services, etc. Such exemplary types of information may be retrieved from the information archive 220 and used to train a direct relation embedding generator to obtain corresponding direct relation embeddings for the user.

FIG. 5D shows an exemplary graph 520 representing users in a network based on their characteristics related to direct relations, in accordance with an embodiment of the present teaching. In this exemplary graph 520, each node represents a user characterized by the user's direct relation embeddings and each edge represents a similarity between two nodes (users) with respect to their direct relations (characterized by their respective direct relation embeddings). In some embodiments, each edge in graph 520 has an associated attribute denoting the similarity between two users, which may correspond to a distance metric determined based on, e.g., the respective direct relation embeddings of the connected users.

Similar to the case for indirect relations, the shorter the distance between two users in graph 520, the more similar the two users are in terms of their direct influence in the network. Based on graph 520, with respect to each user, other users with a similar degree of direct influence may be identified. For example, as illustrated in FIG. 5D, with respect to user 2, user 3, user 4, and user 5 may be considered as having a similar degree of direct influence, when the criterion is that the distance is smaller than 80. In this case, circle 530 encloses these 4 users as having similar direct influence in the network. In some embodiments, the influence of one user, e.g., user A, on another, e.g., user B, may be determined. For instance, it may be formulated as:

$${Influence}_{A / B} = α * {RR}_{A / B} * ( {e}_{A} + {e}_{B} ) + β$$

where e may denote a degree of node, RR may denote a relational rank of node A on B, parameter α may denote a scaling factor, and β may correspond to a bias. Then the overall influence of a user A in the network A may be determined based on the following exemplary formulation:

$$Overall {Influence}_{A} = ( {\sum }_{k = 1}^{n} Infuence A / k ) / n$$

As discussed herein, the indirect and direct influence of users as determined according to the present teaching may be used to obtain a representation for each user, representing the accumulated influence of the user on others in the network, whether directly or indirectly. FIG. 5E shows an exemplary scheme for generating a representation of a user by aggregating relevant indirect relation embeddings and direct relation embeddings associated with the user, in accordance with an embodiment of the present teaching. In this illustrated embodiment, a user representation is determined, via aggregating average indirect relation embeddings associated with the user as well as the user's direct relation embeddings. The integration may take different forms, depending on application needs or experimental results. For instance, the integration may correspond to an average of the indirect and direct relation embeddings.

With the illustrated types of information used to determine a user's indirect and direct relation embeddings (FIGS. 5A, 5C), the graph representations (FIGS. 5B and 5D) depicting how the user relates to others, as well as the exemplary scheme to combine indirect and direct relation embeddings (FIG. 5E), a representation for the user may be obtained to characterize the user's influence in the network.

FIG. 4B is a flowchart of an exemplary process for the representation generator 300, in accordance with an embodiment of the present teaching. Based on information archived in 220, the indirect relation embedding generator 400 generates, at 450, indirect relation embeddings for different users. Based on the indirection relation embeddings obtained for users, the indirect relation graph generator 410 creates, at 455, an indirect relation graph 500 with attributes determined based on users' indirect relation embeddings. Similarly, the direct relation embedding generator 420 access information collected in archive 220, it generates, at 460, direct relation embeddings for users, which are then utilized by the direct relation graph generator 430 to create, at 465, a direct relation graph 520 with edge attributes computed based on direct relation embeddings associated with the connected nodes.

To aggregate indirect and direct relation embeddings to obtain a representation for each user, the representation creator 440 may access, at 470, indirect influence circle criteria 445 specified to define indirect influence circle for each user (illustrated as 510 in FIG. 5B). Based on such indirect influence circle with respect to each user, the representation creator 440 may determine, at 475, average indirect relation embeddings for the user based on indirect relation embeddings of users in the circle and then aggregate, at 480, the average indirect relation embeddings of users in the circle with the user's direct relation embeddings. The aggregated embeddings may then be used by the representation creator 440 to generate, at 485, a representation for each of the users.

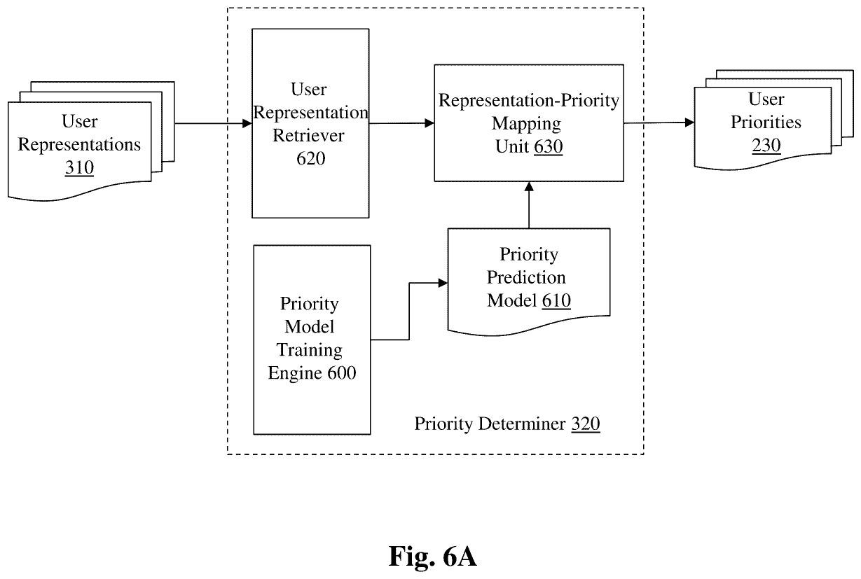

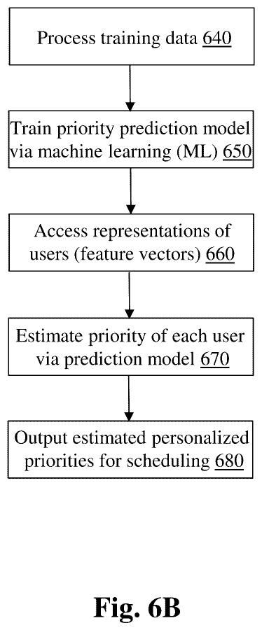

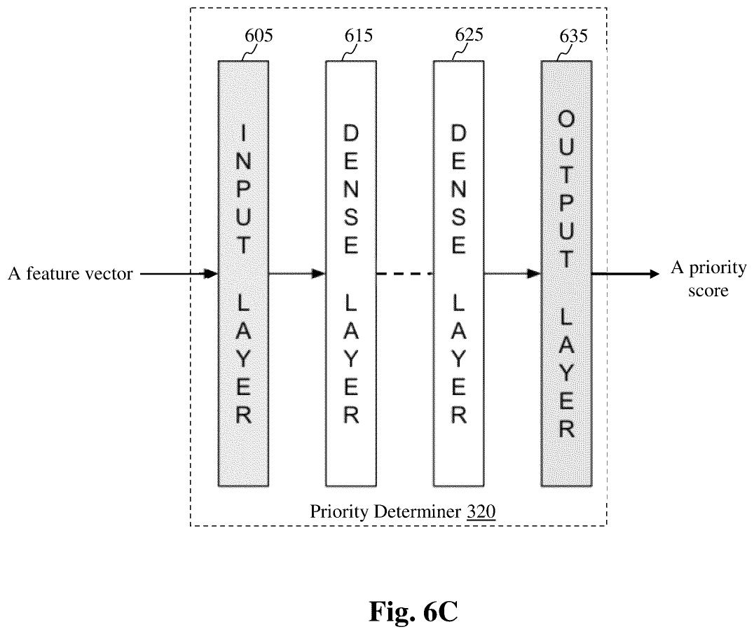

As shown in FIG. 3A, such generated user representations 310 may then be used by the priority determiner 320 to obtain personalized user priorities 230. FIG. 6A depicts an exemplary high level system diagram of the priority determiner 320, in accordance with an embodiment of the present teaching. In this illustrated embodiment, the priority determiner 320 takes a user representation as an input and outputs a user priority based on a priority prediction model 610, which may be trained via machine learning based on training data from past performance data so that it may estimate a priority of a user given a representation of the user obtained according to the present teaching. The priority determiner 320 may include a priority model training engine 600 for deriving the priority prediction model 610 via machine learning, a user representation retriever 620 for accessing a representation for each user, and a representation-priority mapping unit 630 that maps the retrieved user representation to a priority of the user based on the priority prediction model 610. Through this process, priorities 230 for users active in the network are estimated and may be used by the priority-based network update engine 240 (see FIG. 2A) to carry out network update based on some schedules determined according to the estimated user priorities.

FIG. 6B is a flowchart of an exemplary process of the priority determiner 320, in accordance with an embodiment of the present teaching. To train the priority prediction model 610, the priority model training engine 600 processes, at 640, training data and train, at 650, the priority prediction model via machine learning. Based on the trained priority prediction model 610, the user representation retriever 620 accesses, at 660, user representations obtained based on their respective indirect and direct relations with others in the network. The representation-priority mapping unit 630 may then estimate, at 670, the personalized priority metric for each user based on the corresponding user representation in accordance with the priority prediction model 610. The process may repeat until the priority of each of the users in the network is estimated. In some embodiments, users may be ranked according to their overall level of influence in the network so that only users that are ranked sufficiently high may further be considered for assessing the associated priorities. In this way, users who have negligible levels of network influence may not be further assessed as to their priorities to, e.g., minimize the computation to enhance processing efficiency. In some embodiments, the estimate priority may be represented as a priority score and may be used to assess the importance of each user. The estimated user priorities are then output at 680.

In some embodiments, artificial neural network (ANN) may be adopted to implement the priority determiner 320. FIG. 6C shows an exemplary ANN architecture constructed to realize the priority determiner 320, in accordance with an embodiment of the present teaching. In this illustrated embodiment, the priority determiner 320 may be realized using a multi-layer ANN with an input layer 605 to take an input feature vector corresponding to a user representation and an output layer 635 that generates an estimated priority for a user represented by the input feature vector. The ANN priority determiner 630 in this embodiment may also include one or more intermediate layers 615-625, some of which may be dense layers. The connections between adjacent layers may be partial or fully connected. The ANN priority determiner 320 may be constructed with learnable parameters either within the layers or associated with the connections linking different layers. During machine training, each of the learnable parameters may be adjusted according to learning result so that the learned parameters enable the priority determiner 320 to predict an appropriate priority score based on the input user representation.

Based on such personalized assessment as to importance of different users located in different geolocations, network update may be scheduled to minimize the negative impact on more important users. Compared with blanket priority schemes conventionally adopted, the hyper-personalized approach to capture the most important users as to their network influence according to the present teaching enables network update to be executed in a manner to minimize the negative impact on those users that are the most influential in the network. In addition, as the indirect/direct relations to be used to characterize a user's influence may be continually monitored and assessed, the most influential users may be assessed adaptively based on the network dynamics so that the network updates may accordingly be scheduled in an adaptive manner to maintain the minimum negative impact to the most important users.

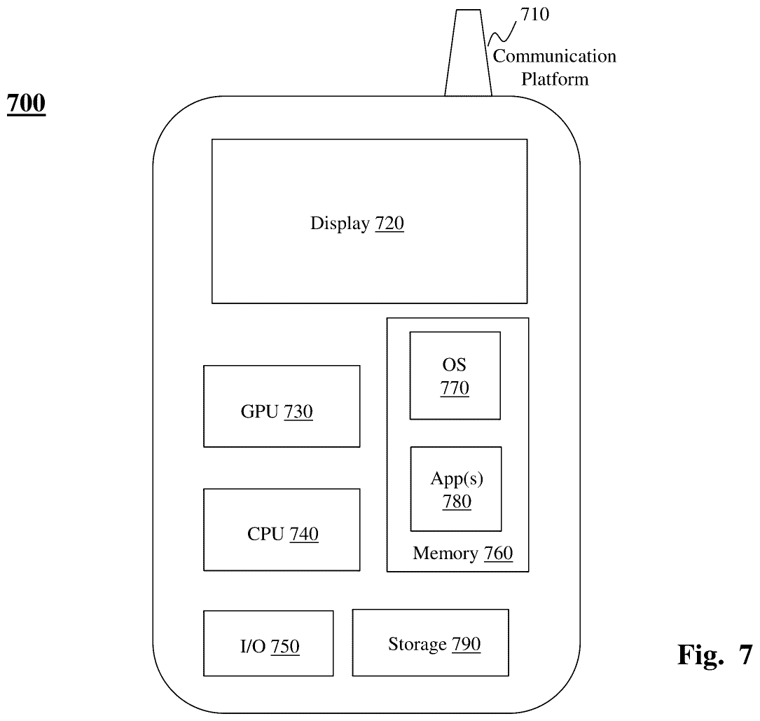

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or a mobile computational unit in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.) and one or more applications 780 may be loaded into memory 760 from storage 790 in order to be executed by the CPU 740. The applications 780 may include a user interface or any other suitable mobile apps for information exchange, analytics, and management according to the present teaching on, at least partially, the mobile device 700. User interactions, if any, may be achieved via the I/O devices 750 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

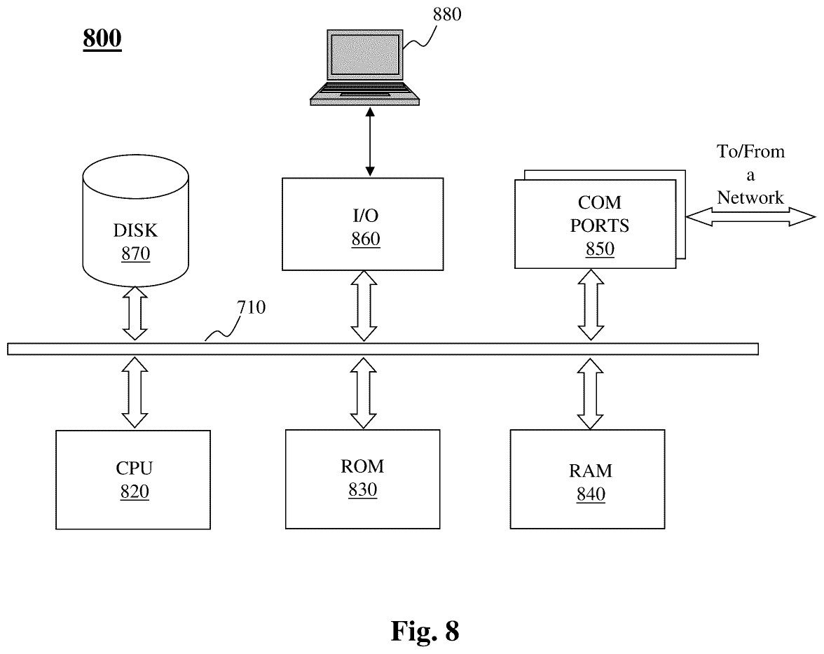

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information processing and analytical method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
collecting information related to network activities of multiple users active on a network;
with respect to each of the multiple users,
identifying, from the information associated with the user, first information related to indirect relations between the user and others of the multiple users and second information related to direct relations between the user and the others,
obtaining, based on the first information, indirect relation embeddings characterizing the user's indirect network influence via the indirect relations,
obtaining, based on the second information, direct relation embeddings characterizing the user's direct network influence via the direct relations,
creating a representation of the user based on the indirect relation embeddings and the direct relation embeddings, wherein the representation is indicative of the user's network influence, and
predicting, using a machine trained prediction model, personalized priority of the user based on the representation of the user;
obtaining a schedule for network update based on priorities of the multiple users; and
conducting the network update according to the network update schedule.

2. The method of claim 1, wherein the first information includes at least one or more of:
intents the user exhibited in communications including call, and chats;
transactions the user conducted with others in the network;
websites the user browsed;
searches the user performed and time spent in the searches;
geographic locations the user was present with competitors' offers;
a profile of the user; and
sentiments/emotions detected of the user.

3. The method of claim 1, wherein the second information includes:
frequencies of call, chat, and messaging activities;
geolocation proximities between the user and others in the call, chat, and messaging activities;
proximities between the user and the others in social media settings; and
uses of services from competitors.

4. The method of claim 1, further comprising:
constructing an indirect relation graph based on indirect relation embeddings for the multiple users with each node representing a user with the user's indirect relation embeddings and each edge having a first attribute thereof indicative of similarity of two users in terms of indirect network influence; and
constructing a direct relation graph based on direct relation embeddings for the multiple users with each node representing a user with the user's direct relation embeddings and each edge having a second attribute thereof indicative of similarity of two users in terms of direct network influence.

5. The method of claim 4, wherein
the first attribute corresponds to a distance measure computed based on the indirect relation embeddings of the two users; and
the second attribute corresponds to a distance measure computed based on the direct relation embeddings of the two users.

6. The method of claim 4, wherein the creating a representation of the user comprises:
determining average indirect relation embeddings based on indirect relation graph;
aggregating the average indirect relation embeddings with the user's direct relation embeddings; and
creating the representation of the user based on the aggregated indirect relation embeddings.

7. The method of claim 6, wherein the determining average indirect relation embeddings comprises:
retrieving a pre-determined criterion;
identifying, with respect to a node in the indirect relation graph corresponding to the user, one or more other nodes in the indirect relation graph with first attributes satisfying the pre-determined criterion; and
obtaining the average indirect relation embeddings based on the indirect relation embeddings of the one or more other nodes.

8. A machine readable and non-transitory medium having information recorded thereon, wherein the information, when read by the machine, causes the machine to perform the following steps:
collecting information related to network activities of multiple users active on a network;
with respect to each of the multiple users,
identifying, from the information associated with the user, first information related to indirect relations between the user and others of the multiple users and second information related to direct relations between the user and the others,
obtaining, based on the first information, indirect relation embeddings characterizing the user's indirect network influence via the indirect relations,
obtaining, based on the second information, direct relation embeddings characterizing the user's direct network influence via the direct relations,
creating a representation of the user based on the indirect relation embeddings and the direct relation embeddings, wherein the representation is indicative of the user's network influence, and
predicting, using a machine trained prediction model, personalized priority of the user based on the representation of the user;
obtaining a schedule for network update based on priorities of the multiple users; and
conducting the network update according to the network update schedule.

9. The medium of claim 8, wherein the first information includes at least one or more of:
intents the user exhibited in communications including call, and chats;
transactions the user conducted with others in the network;
websites the user browsed;
searches the user performed and time spent in the searches;
geographic locations the user was present with competitors' offers;
a profile of the user; and
sentiments/emotions detected of the user.

10. The medium of claim 8, wherein the second information includes:
frequencies of call, chat, and messaging activities;
geolocation proximities between the user and others in the call, chat, and messaging activities;
proximities between the user and the others in social media settings; and
uses of services from competitors.

11. The medium of claim 8, wherein the information, when read by the machine, further causes the machine to perform the following steps:
constructing an indirect relation graph based on indirect relation embeddings for the multiple users with each node representing a user with the user's indirect relation embeddings and each edge having a first attribute thereof indicative of similarity of two users in terms of indirect network influence; and
constructing a direct relation graph based on direct relation embeddings for the multiple users with each node representing a user with the user's direct relation embeddings and each edge having a second attribute thereof indicative of similarity of two users in terms of direct network influence.

12. The medium of claim 11, wherein
the first attribute corresponds to a distance measure computed based on the indirect relation embeddings of the two users; and
the second attribute corresponds to a distance measure computed based on the direct relation embeddings of the two users.

13. The medium of claim 11, wherein the creating a representation of the user comprises:
determining average indirect relation embeddings based on indirect relation graph;
aggregating the average indirect relation embeddings with the user's direct relation embeddings; and
creating the representation of the user based on the aggregated indirect relation embeddings.

14. The medium of claim 13, wherein the determining average indirect relation embeddings comprises:
retrieving a pre-determined criterion;
identifying, with respect to a node in the indirect relation graph corresponding to the user, one or more other nodes in the indirect relation graph with first attributes satisfying the pre-determined criterion; and
obtaining the average indirect relation embeddings based on the indirect relation embeddings of the one or more other nodes.

15. A system, comprising:
an information collector implemented by a processor and configured for collecting information related to network activities of multiple users active on a network;
a priority determination module implemented by a processor and configured for, with respect to each of the multiple users,
identifying, from the information associated with the user, first information related to indirect relations between the user and others of the multiple users and second information related to direct relations between the user and the others,
obtaining, based on the first information, indirect relation embeddings characterizing the user's indirect network influence via the indirect relations,
obtaining, based on the second information, direct relation embeddings characterizing the user's direct network influence via the direct relations,
creating a representation of the user based on the indirect relation embeddings and the direct relation embeddings, wherein the representation is indicative of the user's network influence, and
predicting, using a machine trained prediction model, personalized priority of the user based on the representation of the user; and
a priority-based network update engine implemented by a processor and configured for
obtaining a schedule for network update based on priorities of the multiple users, and
conducting the network update according to the network update schedule.

16. The system of claim 15, wherein
the first information includes at least one or more of:
intents the user exhibited in communications including call, and chats,
transactions the user conducted with others in the network,
websites the user browsed,
searches the user performed and time spent in the searches,
geographic locations the user was present with competitors' offers,
a profile of the user, and
sentiments/emotions detected of the user; and
the second information includes at least one or more of:
frequencies of call, chat, and messaging activities,
geolocation proximities between the user and others in the call, chat, and messaging activities,
proximities between the user and the others in social media settings, and
uses of services from competitors.

17. The system of claim 15, wherein the priority determination module is further configured for:
constructing an indirect relation graph based on indirect relation embeddings for the multiple users with each node representing a user with the user's indirect relation embeddings and each edge having a first attribute thereof indicative of similarity of two users in terms of indirect network influence; and
constructing a direct relation graph based on direct relation embeddings for the multiple users with each node representing a user with the user's direct relation embeddings and each edge having a second attribute thereof indicative of similarity of two users in terms of direct network influence.

18. The system of claim 17, wherein
the first attribute corresponds to a distance measure computed based on the indirect relation embeddings of the two users; and
the second attribute corresponds to a distance measure computed based on the direct relation embeddings of the two users.

19. The system of claim 17, wherein the creating a representation of the user comprises:
determining average indirect relation embeddings based on indirect relation graph;
aggregating the average indirect relation embeddings with the user's direct relation embeddings; and
creating the representation of the user based on the aggregated indirect relation embeddings.

20. The system of claim 19, wherein the determining average indirect relation embeddings comprises:
retrieving a pre-determined criterion;
identifying, with respect to a node in the indirect relation graph corresponding to the user, one or more other nodes in the indirect relation graph with first attributes satisfying the pre-determined criterion; and
obtaining the average indirect relation embeddings based on the indirect relation embeddings of the one or more other nodes.
